(19) United States
(12) Patent Application Publication
(10) Pub. No.: US 2024/0033793 A1
(43) Pub. Date: Feb. 1, 2024

(54) REHABILITATION MATERIAL FOR REDUCING THE BIOAVAILABILITY OF Cd IN SOIL AND USE IN IMMOBILIZATION REMEDIATION OF WEAKLY ALKALINE SOIL THEREOF

(71) Applicants: Institute of Soil Science, Chinese Academy of Sciences, Jiangsu (CN); Jiangxi Jiedi Environmental Treatment & Ecological Technology Co., Ltd., Jiangxi (CN)

(72) Inventors: Jing Zhou, Jiangsu (CN); Ruizhi Xia, Jiangsu (CN); Jiani Liang, Jiangsu (CN); Chen Zhang, Jiangsu (CN); Jun Zhou, Jiangsu (CN)

(21) Appl. No.: 17/434,887

(22) PCT Filed: Jan. 21, 2021
(86) PCT No.: PCT/CN2021/073017

§ 371 Date: Jul. 28, 2022

(51) Int. Cl. B09C 1/08; C09K 17/42

(52) U.S. Cl. CPC B09C 1/08; C09K 17/42; B09C 2101/00

(57) ABSTRACT

A rehabilitation material for reducing the bioavailability of Cd in soil and its use in immobilization remediation of weakly alkaline soil are disclosed. The rehabilitation material includes an iron mine tailing and an alkali lignin, wherein the iron mine tailing accounts for 80-90% of the sum of the masses of the iron mine tailing and the alkali lignin, and the iron mine tailing is prepared by mixing an iron tailing, mica, and dolomite in a mass ratio of 1:1.5:2.5, and calcining the resulting mixture at 1100° C. for 1 hour.

### TECHNICAL FIELD

The present disclosure belongs to the technical field of prevention and control of heavy metal pollution in soil, and particularly relates to a rehabilitation material for reducing the bioavailability of Cd in soil and its use in immobilization remediation of weakly alkaline soil.

### BACKGROUND

In recent years, heavy metal pollution in cultivated land is becoming increasingly serious in China. Among the heavy metals, Cd (Cd) ranks the first, and Cd concentration in 7.0% of the cultivated land exceeds the Ministry of Environmental Protection (MEP) limit. Cd is a non-essential element in organisms. Due to its high mobility, high toxicity, high accumulation, and difficulty in elimination, it is regarded as one of the most biologically toxic heavy metal. After entering the soil, Cd is easy to be absorbed and enriched by plants because of its high biological activity. Meanwhile, Cd is thus transferred through food chains, which is a threat to human health, including osteoporosis, arteriosclerosis, and kidney damage.

A technology mostly used to treat heavy metal-contaminated cultivated land is to add rehabilitation materials to immobilize heavy metals and reduce the absorption of heavy metals in soil and transform the soil heavy metal fractions to lower-solubility fractions, immobilized fractions, and lower-toxicity fractions, thereby reducing the bioavailability and environment risk of heavy metals in the contaminated soil. Because of the features, such as quick remediation, low cost, and simple operation, the remediation process could work with agricultural production, which is one of the best methods for actual remediation of large-area slightly and moderately heavy metals-contaminated soil.

Large differences in soil properties are among different regions. At present, the immobilization remediation technology for acid soil is well-developed. Most of rehabilitation materials for remediation of Cd-contaminated acid soil function by increasing the soil pH value, and reduce the Cd activity by increasing the pH value of soil, thereby reducing the Cd bioavailability in soil. For example, after alkaline materials, such as apatite or lime, are applied, the soil pH value is significantly increased, thereby promoting the formation of hydroxide or carbonate precipitation of heavy metal ions in soil. However, for weakly alkaline soil with a pH value of 7.1 to 7.5, the background pH value of the soil is relatively high. If alkaline materials such as apatite or lime are added to weakly alkaline soil, the soil pH values would increase greatly, even to above 7.5, thereby causing overly alkaline. Overly alkaline soil would reduce the availability of soil nutrients, resulting in declined soil fertility quality and damage to soil structure. Additionally, this is not conducive to the growth and development of plants, and may cause failure to absorb nutrients normally, closed stomata, and damage to plant tissues. Moreover, overly alkaline soil is not conducive to the activities of microorganisms in soil. At present, there is almost no long-term effective method for immobilization remediation of Cd-contaminated weakly alkaline soil worldwide.

### SUMMARY

An object of the present disclosure is to provide a rehabilitation material for reducing the bioavailability of Cd in soil and its use in immobilization remediation of weakly alkaline soil. The rehabilitation material according to the present disclosure makes it possible to effectively reduce the bioavailability of heavy metal Cd in weakly alkaline soil, and ensure a long-term effective immobilization effect on heavy metal Cd in soil.

To achieve the object, the present disclosure provides the following technical solutions.

The present disclosure provides a rehabilitation material for reducing the bioavailability of Cd in soil, comprising an iron mine tailing and an alkali lignin; wherein the iron mine tailing accounts for 80-90% of the sum of the masses of the iron mine tailing and the alkali lignin, and the iron mine tailing is obtained by mixing an iron tailing, mica, and dolomite in a mass ratio of 1:1.5:2.5, and calcining the resulting mixture at 1100° C. for 1 hour.

In some embodiments, the alkali lignin comprises 42-46% by mass of C element, and the alkali lignin comprises 18-21% by mass of ash. In some embodiments, the ash comprises 27-33% by mass of Si, and 14-18% by mass of K.

In some embodiments, the alkali lignin has a weight-average molecular weight of 20,000-25,000 and a number-average molecular weight of 150-180.

In some embodiments, the iron tailing comprises 65-75% by mass of SiO₂. In some embodiments, the mica comprises 7-11% by mass of K₂O. In some embodiments, the dolomite comprises 27-32% by mass of CaO, and 15-25% by mass of MgO.

The present disclosure provides use of the rehabilitation material for reducing the bioavailability of Cd in soil as described in above-mentioned technical solution in immobilization remediation of weakly alkaline soil, wherein the weakly alkaline soil has a pH value of 7.1-7.5.

In some embodiments, the use comprises

(1) applying the rehabilitation material to the cultivation layer of the weakly alkaline soil; and

(2) irrigating the cultivation layer, and then balancing so that the rehabilitation material and the cultivation layer are mixed to be uniform.

In some embodiments, the cultivation layer is the surface layer of weakly alkaline soil within a depth of 0-20 cm.

In some embodiments, the rehabilitation material is applied in an amount of 0.35-0.45% of the dry weight of the cultivation layer.

In some embodiments, the rehabilitation material is applied in an amount of 0.4% of the dry weight of the cultivation layer.

In some embodiments, irrigating the cultivation layer is to keep the moisture content of the cultivation layer not less than 30% of the saturated moisture content of the cultivation layer, and the balancing is performed for 4-6 days.

The present disclosure provides a rehabilitation material for reducing the bioavailability of Cd in soil, comprising an iron mine tailing and an alkali lignin, wherein the iron mine tailing accounts for 80-90% of the sum of the masses of the iron mine tailing and the alkali lignin, and the iron mine tailing is obtained by mixing an iron tailing, mica, and dolomite in a mass ratio of 1:1.5:2.5, and calcining the resulting mixture at 1100° C. for 1 hour. In the present disclosure, on the one hand, the iron mine tailing contains a large number of metal oxides, such as iron oxide, aluminum oxide and silicon oxide, which have a large specific surface area and many adsorption sites, and could form a relatively stable structure with heavy metal Cd. Also, due to the presence of metal oxides in the iron mine tailing (such as iron oxide, aluminum oxide, calcium oxide, magnesium oxide, potassium oxide, silicon oxide), the pH value of the soil increases slightly. Increase of alkaline groups in soil, such as hydroxide, silicate, and carbonate, results in the formation of cadmium hydroxide and silicate precipitation and reduces the bioavailability of Cd in soil. On the other hand, alkali lignin could adsorb heavy metal Cd and organically complex with heavy metal Cd, and could buffer the increase in pH value of soil caused by the iron mine tailing (not causing the soil to be too alkaline), thereby achieving the organically complexing and surface adsorption effect of the alkali lignin and the iron mine tailing on Cd to a greater extent before activating Cd in soil.

Therefore, in the present disclosure, the iron mine tailing-alkali lignin composite passivation material is used as the rehabilitation material, which could effectively adsorb heavy metal Cd in the weakly alkaline soil and complex with it to achieve the immobilization of heavy metal Cd, thereby reducing the bioavailability of heavy metal Cd in weakly alkaline soil and ensuring a long-term effective immobilization effect on heavy metal Cd in soil. Moreover, the combination of iron mine tailing and alkali lignin could balance the pH value of weakly alkaline soil, avoiding overly alkaline. In addition, the present disclosure also provides a rehabilitation material that is low in cost, harmless, and does not cause secondary pollution to the soil.

Further, the rehabilitation material of the present disclosure may be applied in a small amount, and an amount of 0.35-0.45% (in relative to the dry mass of the cultivation layer of the weakly alkaline soil) could effectively reduce the bioavailability of Cd in weakly alkaline soil.

### BRIEF DESCRIPTION OF THE DRAWINGS

FIG. 1 is a diagram showing the changes of Cd fractions in soil after 30-day culture by applying rehabilitation material A and rehabilitation material B respectively in one embodiment.

FIG. 2 is a diagram showing the changes of Cd fractions in soil after 90-day culture by applying rehabilitation material A and rehabilitation material B respectively in one embodiment.

### DETAILED DESCRIPTION

The present disclosure provides a rehabilitation material for reducing the bioavailability of Cd in soil, comprising an iron mine tailing and an alkali lignin, wherein the iron mine tailing accounts for 80-90% of the sum of the masses of the iron mine tailing and the alkali lignin, and the iron mine tailing is obtained by mixing an iron tailing, mica and dolomite in a mass ratio of 1:1.5:2.5, and calcining the resulting mixture at 1100° C.

The rehabilitation material for reducing the bioavailability of Cd in soil according to the present disclosure comprises an iron mine tailing, and the iron mine tailing accounts for 80-90% of the sum of the masses of the iron mine tailing and the alkali lignin, preferably 85-86%. The iron mine tailing is obtained by mixing an iron tailing, mica, and dolomite in a mass ratio of 1:1.5:2.5, and calcining the resulting mixture at 1100° C. In some embodiments of the present disclosure, the iron mine tailing comprises 65-75% by mass of SiO₂, and more preferably 69-72%. In some embodiments, the mica comprises 7-11% by mass of K₂O, and more preferably 8-10.5%. In some embodiments, the dolomite comprises 27-32% by mass of CaO, and more preferably 28-31%. In some embodiments, the dolomite comprises 15-25% by mass of MgO, and more preferably 18-22%. In the present disclosure, there is no special limitation on the source of the iron tailing, mica and dolomite, and commercially available iron tailing, mica and dolomite well known in the art may be used, as long as the above product specifications could be met. In some embodiments of the present disclosure, dolomite is produced associating with iron ore, as a by-product of iron ore mining, and mica is obtained by flotation from the iron ore tailing. Therefore, the present disclosure makes it possible to realize the comprehensive utilization of tailing resources. In the present disclosure, there is no special limitation on the means for mixing the iron tailing, mica and dolomite, and any means well known in the art may be used. In the present disclosure, calcining the resulting mixture is performed as follows: mixing an iron tailing, mica and dolomite, placing the resulting mixture in a crucible, and leaving the resulting mixture to stand in a muffle furnace and calcining, naturally cooling the calcined product to room temperature to obtain the iron mine tailing. In the present disclosure, during the calcination, the raw materials iron tailing, mica and dolomite undergo multiple solid-phase reactions at a high temperature to break the original lattice, and chemically inert mineral materials are reorganized to produce water-soluble or citric acid-soluble active substances, thereby achieving the effect of effectively releasing beneficial elements. The calcination according to the present disclosure could significantly increase the active content of SiO₂, K₂O, CaO and MgO, and obtain a highly active iron mine tailing. The iron mine tailing comprises 16-20 wt % of active SiO₂, 2-3 wt % of active K₂O, 16-18 wt % of active CaO, and 11-13 wt % of active MgO.

In the present disclosure, the iron mine tailing contains a large number of metal oxides, such as iron oxide, aluminum oxide and silicon oxide, which have a large specific surface area and many adsorption sites, and could form a relatively stable structure with heavy metal Cd. Also, due to the presence of metal oxides in the iron mine tailing (such as iron oxide, aluminum oxide, calcium oxide, magnesium oxide, potassium oxide, silicon oxide), the pH value of soil increases slightly. The increase of alkaline groups in soil, such as hydroxide, silicate and carbonate, results in the formation of cadmium hydroxide and silicate precipitation, thereby reducing the bioavailability of Cd in soil.

The rehabilitation material for reducing the bioavailability of Cd in soil according to the present disclosure comprises an alkali lignin. In some embodiments, the alkali lignin comprises 42-46% by mass of C element, and more preferably 43-44%. In some embodiments, the alkali lignin comprises 18-21% by mass of ash, and more preferably 19-20%. In some embodiments, the ash comprises 27-33% by mass of Si, and more preferably 28-32%. In some embodiments, the ash comprises 14-18% by mass of K, and more preferably 15-16%. In some embodiments of the present disclosure, the alkali lignin has a weight-average molecular weight of 20,000-25,000, and more preferably 21,000-24,000. In some embodiments, the alkali lignin has a number-average molecular weight of 150-180, and more preferably 160-170.

In some embodiments of the present disclosure, the alkali lignin is prepared by using a straw as a raw material, and the straw is preferably wheat straw. In the present disclosure, there is no special limitation on the specific preparation method of the alkali lignin, and a preparation method well known in the art may be used. In some embodiments, the alkali lignin is prepared by a process including the following steps: crushing a wheat straw, and pretreating the crushed wheat straw to remove ash and impurities, separating hemicellulose, cellulose, and lignin step by step, and then hydrolyzing the separated lignin under alkaline conditions with a pH value of 11-12, to obtain the alkali lignin.

In the present disclosure, the alkali lignin comprises more low molecular weight components and higher level of ash (comprising Si and K), and has higher molecular weight, higher carbon content and higher crosslinking reaction activity. In the present disclosure, the alkali lignin could organically complex with heavy metal Cd in soil, and could effectively adsorb the exchangeable Cd in soil by means of special porous structure on its surface. Also, it could buffer the increase in pH value of soil caused by iron mine tailing, thereby achieving organically complexing and surface adsorption effect of the alkali lignin and the iron mine tailing on Cd to a greater extent before activating Cd in soil.

In the present disclosure, the rehabilitation material for reducing the bioavailability of Cd in soil may be obtained by mixing an iron mine tailing and an alkali lignin. In the present disclosure, there is no special limitation on the means for mixing, any means well known in the art may be used, as long as the iron mine tailing and the alkali lignin could be mixed to be uniform. The method for preparing the rehabilitation material according to the present disclosure is simple, easy in operation, and has great market promotion value.

The present disclosure provides use of the rehabilitation material as described in the above technical solutions in immobilization remediation of weakly alkaline soil, wherein the weakly alkaline soil has a pH value of 7.1-7.5. In the present disclosure, the iron mine tailing-alkali lignin composite passivation material is used as the rehabilitation material, which could effectively adsorb heavy metal Cd in the weakly alkaline soil and complex with it to achieve the immobilization of heavy metal Cd, thereby reducing the bioavailability of heavy metal Cd in weakly alkaline soil and ensuring a long-term effective immobilization effect on heavy metal Cd in soil. Moreover, the combination of iron mine tailing and the alkali lignin could balance the pH value of weakly alkaline soil, avoiding overly alkaline.

In some embodiments of the present disclosure, the use comprises the follows steps:
applying the rehabilitation material to the cultivation layer of the weakly alkaline soil; and
irrigating the cultivation layer, and balancing so that the rehabilitation material and the cultivation layer are mixed to be uniform.

In the present disclosure, there is no special limitation on the source of the weakly alkaline soil, the rehabilitation material according to the present disclosure may be applied to any soil having a pH value within the above range. In some embodiments, the cultivation layer is the surface layer of weakly alkaline soil within a depth of 0-20 cm. In some embodiments, the rehabilitation material is applied in an amount of 0.35-0.45% of the dry weight of the cultivation layer, and more preferably 0.4%. In some embodiments, irrigating the cultivation layer is to keep the moisture content of the cultivation layer not less than 30% of the saturated moisture content of the cultivation layer, and more preferably 30-40%. In some embodiments, the balancing is performed for 4-6 days, and more preferably 5 days.

The rehabilitation material for reducing the bioavailability of Cd in soil and its use in immobilization remediation of weakly alkaline soil according to the present disclosure will be described below in detail with reference to examples, but the examples may not be construed as a limitation to the protection scope of the present disclosure.

### Example 1

Iron tailing (comprising 69.32 wt % of SiO₂), mica (comprising 10.16 wt % of K₂O), dolomite (comprising 30.20 wt % of CaO, and 21.0 wt % of MgO) were used as raw materials, and mixed in a mass ratio of 1:1.5:2.5, and the resulting mixture was calcinated at 1100° C. for 1 hour, and naturally cooled, obtaining an iron mine tailing.

Alkali lignin was prepared from a wheat straw (during which the wheat straw was crushed and pretreated to remove ash and impurities, and then the hemicellulose, cellulose and lignin were separated step by step, the separated lignin was hydrolyzed under alkaline conditions with a pH value of 11.5 to obtain the alkali lignin). The content of C element in the alkaline lignin is 44.56% by mass, and the content of ash in the alkaline lignin is 19.2% by mass. The content of Si in the ash is 30.21% by mass, and the content of K in the ash is 16.96% by mass. The alkali lignin has a weight-average molecular weight of 24,450, and a number-average molecular weight of 164.

The iron mine tailing and the alkali lignin were mixed in a mass ratio of 8:2 (the iron mine tailing accounted for 80% of the total mass of the iron mine tailing and the alkali lignin) and then stirred to be uniform, obtaining the rehabilitation material, which was labeled as rehabilitation material A.

### Comparative Example 1

The rehabilitation material was prepared as described in Example 1, except that the iron mine tailing and the alkali lignin were mixed in a mass ratio of 7:3 (the iron mine tailing accounted for 70% of the total mass of the iron mine tailing and the alkali lignin) and then stirred to be uniform, obtaining the rehabilitation material, which was labeled as rehabilitation material B.

### Comparative Example 2

The iron mine tailing was canceled, and only the alkali lignin (which is the same as in Example 1) was used as the rehabilitation material, labeled as rehabilitation material C.

### Comparative Example 3

The alkali lignin was canceled, and only the iron mine tailing (which is the same as in Example 1) was used as the rehabilitation material, labeled as rehabilitation material D.

### Use Example

The soil for this study was collected from shajiang black soil (0-20 cm deep from the surface, i.e. the cultivation layer) of the cultivated land in Quanwangtou Village, Jiawang District, Xuzhou, Jiangsu, China, and it has a Cd content of 1.12 mg/kg, and its basic physical and chemical properties were shown in Table 1, indicating weakly alkaline soil. According to “Soil Environmental Quality-Risk Control Standard for Soil Contamination of Agricultural Land” (GB 15618-2018), the Cd content in soil between the risk screening values and risk intervention values of soil Cd of agricultural land represents slight and moderate contamination of soil. 92.9% of Cd-contaminated cultivated land in China was within this range (A joint report on the current status of soil contamination in China issued by the Ministry of Environmental Protection (MEP) and the Ministry of Land and Resources (MLR) of the People's Republic of China in 2014).

TABLE 1
Basic physical and chemical properties of the test soil

| | | | Organic | Total | Available | Available | Available | Total |
|---|---|---|---|---|---|---|---|---|
| Soil | | CEC | matter | nitrogen | nitrogen | phosphorus | potassium | Cd |
| type | pH | cmol/kg | g/kg | g/kg | mg/kg | mg/kg | mg/kg | mg/kg |
| Sandy | 7.15 | 10.63 | 9.89 | 2.07 | 84.79 | 85.41 | 163 | 1.12 |
| Soil | | | | | | | | |

500 g of the test soil was sieved through a 2 mm sieve and mixed with the rehabilitation material in the culture vessels at different ratios, and two ratios were set for rehabilitation material A, B, C and D, respectively, the mass percentages of rehabilitation material and the dry weight of soil were 0.2% and 0.4%, respectively, and three paralleling treatments were set for each treatment. Experiment was conducted in an incubator, and soil was cultured in the incubator for 90 days, with a moisture content in soil being 30% of the saturated moisture content (the first 5 days is for the balance, the main growth cycle of general field crops is around 90 days; if the rehabilitation material still has good immobilization effect on the soil after 90-day culture, it means that the effect of the rehabilitation material is continuous and stable, which fits the cycle of soil nutrient absorption during the main growth period of general field crops). The soil samples were taken every 30 days and then air-dried, ground and sieved through a 2 mm sieve before analysis.

The pH value of soil was measured in a mixture of water and soil (with a mass ratio of 2.5:1) by using a pH meter (PB-10 Sartorius, Germany) Cation exchange capacity (CEC) was determined by 8.21 mol/L sodium acetate-flame photometry. The available phosphorus of the soil was measured by 0.03 mol/L NH₄F-0.02 mol/L HCl leaching method. Available potassium in soil was measured by ammonium acetate-leaching and flame photometry. Available nitrogen was measured by alkali-diffusion method. Total nitrogen content of soil was measured by using a Kjeldahl apparatus. The available Cd in soil was measured by leaching with DTPA (diethylene triaminepenta-acetic acid) and determining by using inductively coupled plasma spectrometer (ICP-OES, Thermo Scientific, USA). The standard reference soil material (GBW07445) of International Centre on Global-Scale Geochemistry (IGGE) was used in conjunction with blank experiments and replicates to ensure the accuracy and precision of the digestion procedure.

The effects of the use of rehabilitation material A, rehabilitation material B, and rehabilitation material D on the pH value of soil was shown in Table 2.

TABLE 2
Effects of applying rehabilitation materials on the pH value of soil

| Days | 30 days | | 90 days | |
|---|---|---|---|---|
| Amount | 0.2% | 0.4% | 0.2% | 0.4% |
| Blank Control | 7.15 ± 0.02 | | 7.14 ± 0.017 | |
| Applying | 7.25 ± 0.012 | 7.36 ± 0.026 | 7.10 ± 0.011 | 7.06 ± 0.028 |
| rehabilitation | | | | |
| material A | | | | |
| Applying | 7.21 ± 0.015 | 7.34 ± 0.025 | 7.07 ± 0.011 | 7.12 ± 0.03 |
| rehabilitation | | | | |
| material B | | | | |
| Applying | 7.37 ± 0.021 | 7.43 ± 0.047 | 7.06 ± 0.026 | 7.18 ± 0.047 |
| rehabilitation | | | | |
| material D | | | | |

It can be seen from Table 2 that the pH value of soil, 30 days after being applied with rehabilitation material A in an amount of 0.2%, increases by 0.1 units compared with the blank control, and the pH value of soil, 30 days after being applied with rehabilitation material A in an amount of 0.4%, increases by 0.21 units compared with the blank control. However, for 90 days after being applied with rehabilitation material A, the pH value difference of soil between the treatment group and the blank control group is within 0.1 units. The pH value of soil, 30 days after being applied with rehabilitation material B in an amount of 0.2%, increases by 0.06 units compared with the blank control group, and the pH value of soil, 30 days after being applied with rehabilitation material B in an amount of 0.4%, decreases by 0.19 units compared with the blank control group. For 90 days after being applied with rehabilitation material B, and the pH value difference of soil between the treatment group and the blank control group is within 0.1 units. This indicates that although the pH value of soil increases in all four treatment groups in the short term after being applied with rehabilitation material A and rehabilitation material B, the rehabilitation materials do not have a significant effect on the pH value of soil in the long term and has a low environmental risk. The pH value of soil increases for both amounts (i.e. 0.2% and 0.4%) 30 days after being applied with rehabilitation material D, and the pH increase is larger than that of rehabilitation material A and rehabilitation material B, indicating that alkaline lignin in rehabilitation material A and rehabilitation material B functions to buffer the increase in pH value caused by iron mine tailing.

The content of available Cd in different time periods after applying rehabilitation material A, rehabilitation material B, rehabilitation material C, and rehabilitation material D was shown in Table 3.

TABLE 3
Available Cd content in different time periods after applying the rehabilitation materials (μg/L)

| | Days | | | | | |
|---|---|---|---|---|---|---|
| | 30 days | | 60 days | | 90 days | |
| | Amount | | | | | |
| | 0.2% | 0.4% | 0.2% | 0.4% | 0.2% | 0.4% |
| Blank Control | 396.19 ± 3.58 | | 378.52 ± 3.01 | | 375.20 ± 2.71 | |
| Applying | 342.49 ± 8.69 | 290.38 ± 1.42 | 332.1 ± 9.10 | 303.52 ± 6.96 | 418.52 ± 47.24 | 283.62 ± 37.61 |
| rehabilitation | | | | | | |
| material A | | | | | | |
| Applying | 312.39 ± 1.36 | 308.73 ± 1.69 | 268.54 ± 22.39 | 319.93 ± 21.13 | 375.02 ± 8.43 | 364.30 ± 2.5 |
| rehabilitation | | | | | | |
| material B | | | | | | |
| Applying | 321.08 ± 3.96 | 317.36 ± 7.14 | 355.72 ± 21.34 | 332.93 ± 14.66 | 380.17 ± 2.91 | 409.26 ± 15.19 |
| rehabilitation | | | | | | |
| material C | | | | | | |
| Applying | 326.81 ± 3.65 | 310.14 ± 3.75 | 359.08 ± 13.23 | 345.09 ± 10.28 | 373.36 ± 2.08 | 331.07 ± 13.28 |
| rehabilitation | | | | | | |
| material D | | | | | | |

From Table 3, it can be seen that:

(1) For rehabilitation material A and rehabilitation material B: After culture for 60 days, for the rehabilitation material A, the treatment group has reduced available Cd by 12.26% for the amount of 0.2%, and reduced available Cd by 19.81% for the amount of 0.4%. For the rehabilitation material B, after culture for 60 days, the treatment group has reduced available Cd by 29.06% for the amount of 0.2%, and reduced available Cd by 15.48% for the amount of 0.4%. However, after culture for 90 days, for the rehabilitation material A, there is no significant difference of the available Cd content in soil between the treatment group with the amount of 0.2% and the blank control group, and the treatment group with an amount of 0.4% has reduced available Cd content by 22.41%. For the rehabilitation material B, there is no significant difference in available Cd content in soil between the treatment group (with the amount of 0.2% and 0.4%) and the blank control group. Therefore, the rehabilitation material A has a longer-term immobilization effect than the rehabilitation material B. Moreover, the amount of 0.4% has a better effect than the amount of 0.2%, and when the amount is 0.4%, the available Cd content in soil gradually decreases over time.

(2) For rehabilitation material A and rehabilitation materials C and D: after culture for 60 days, for the rehabilitation material C, the treatment group has reduced available Cd content by 6.02% for the amount of 0.2%, and reduced available Cd content by 12.04% for the amount of 0.4%. However, after culture for 90 days, the treatment groups for different amounts have increased available Cd content in soil. For the rehabilitation material D, after culture for 60 days, the treatment group with the amount of 0.2% has reduced available Cd content in soil by 5.13%, and the treatment group with the amount of 0.4% has reduced available Cd content in soil by 8.83%. However, after culture for 90 days, there is no significant difference between the treatment group with the amount of 0.2% and the blank control group, and the treatment group with the amount of 0.4% has reduced available Cd content by 11.76%. Therefore, it can be shown that rehabilitation material A has an significantly better effect than the single alkali lignin and iron mine tailing in terms of reducing the bioavailability of heavy metal Cd in weakly alkaline soil and the long-term immobilization remediation effect.

Analysis of the changes of Cd fractions in soil after applying rehabilitation material A and rehabilitation material B:

Different types of Cd fractions in soil were extracted by modified European Community Bureau of Reference (BCR) method, such as water-soluble fraction, acetate extraction fraction, reducible fraction, oxidizable fraction, and residual fraction, and the contents thereof were determined by using inductively coupled plasma mass spectrometry (ICP-MS, Thermo Scientific, USA). The standard reference soil material (GBW07445) of IGGE was used to ensure the accuracy and precision of the digestion procedure. The specific method was shown in Table 4.

TABLE 4
Method for extracting different types of Cd fractions in soil

| Form of the element | Extraction methods |
|---|---|
| Water-soluble fraction | Adding deionized water and shaking at room temperature for |
| (WD) | 30 min. |
| Reducible fraction | Adding hydroxylamine hydrochloride solution (40 ml, 0.5 mol/l), |
| (RE) | shaking for 16 hours, leaving to stand, centrifuging, and extracting. |
| Oxidizable fraction | Adding hydrogen peroxide solution at a mass concentration of |
| (OX) | 30%, heating in a water bath (85° C.) for 1 hour, repeating the |
| | above steps twice; cooling, adding 1 mol/L NH₄OAc solution, |
| | shaking at room temperature for 20 min, centrifuging, and |
| | extracting. |
| Acetate extraction | Adding 1 mol · L⁻¹ NH₄OAc solution with a pH value of 7, and |
| fraction (CA) | shaking for 30 min; centrifuging, and extracting. |
| Residual fraction | RES = 100%-WD-RE-OX-CA |
| (RES) | |

The test results of the content of each Cd fraction in soil 30 days and 90 days after applying the rehabilitation materials were shown in Table 5.

TABLE 5
The content of each Cd fraction in soil 30 days and 90
days after applying the rehabilitation materials (μg/L)

| | | | | Acetate | | | |
|---|---|---|---|---|---|---|---|
| | | | | (ammonium | | | |
| | | | Water- | cetate) | | | |
| | | | soluble | extraction | Reducible | Oxidizable | Residual |
| Culture | | | fraction | fraction | fraction | fraction | fraction |
| days | Treatment | Amount | (WD) | (CA) | (RE) | (OX) | (RES) |
| 30 days | Blank Control | / | 82.57 | 156.23 | 99.66 | 123.13 | 738.41 |
| | rehabilitation | The | 35.24 | 101.51 | 100.54 | 144.29 | 818.42 |
| | material A | amount | | | | | |
| | | of 0.2% | | | | | |
| | | The | 52.63 | 93.85 | 95.56 | 134.46 | 823.49 |
| | | amount | | | | | |
| | | of 0.4% | | | | | |
| | rehabilitation | The | 67.92 | 115.42 | 97.34 | 116.37 | 802.95 |
| | material B | amount | | | | | |
| | | of 0.2% | | | | | |
| | | The | 63.30 | 108.21 | 101.61 | 108.37 | 818.52 |
| | | amount | | | | | |
| | | of 0.4% | | | | | |
| 90 days | Blank Control | / | 73.01 | 240.89 | 84.85 | 48.63 | 776.61 |
| | rehabilitation | The | 61.20 | 178.40 | 85.04 | 58.99 | 840.37 |
| | material A | amount | | | | | |
| | | of 0.2% | | | | | |
| | | The | 57.17 | 155.48 | 87.36 | 65.22 | 858.77 |
| | | amount | | | | | |
| | | of 0.4% | | | | | |
| | rehabilitation | The | 56.02 | 180.92 | 89.47 | 69.03 | 828.55 |
| | material B | amount | | | | | |
| | | of 0.2% | | | | | |
| | | The | 56.71 | 179.26 | 91.69 | 71.05 | 825.29 |
| | | amount | | | | | |
| | | of 0.4% | | | | | |

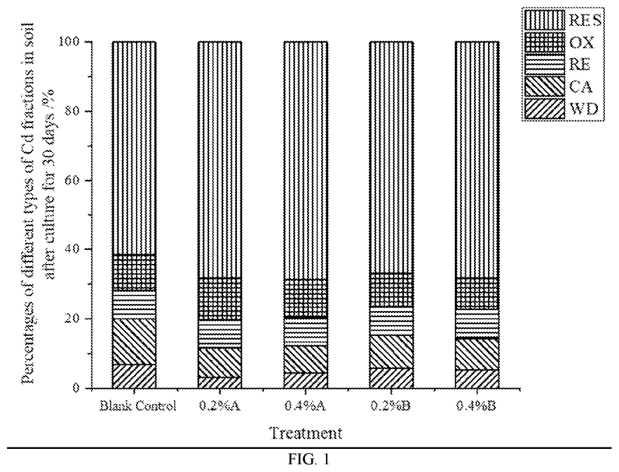

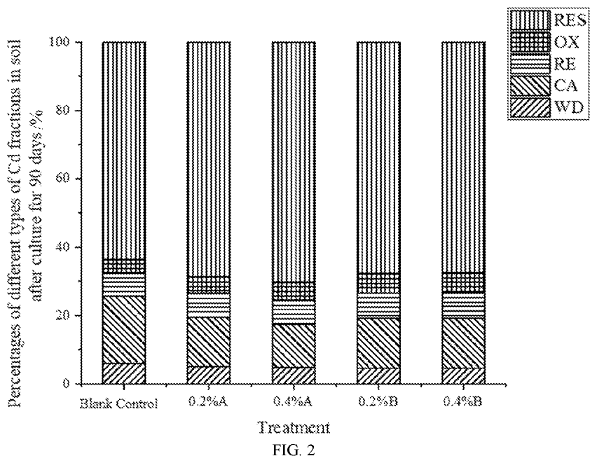

FIG. 1 and FIG. 2 were drawn according to the test results in Table 5.

As can be seen from Table 5 and FIG. 1, after culture for 30 days, for the rehabilitation material A, the treatment groups with the amount of 0.2% and 0.4% have significant effect compared with the blank control group, and have reduced WD content and CA content by 36%-57% and 35%-40%, respectively. In terms of RE content and OX content in soil, there is no significant difference between the treatment groups and the blank control group. The treatment groups have increased RES content in soil by 11%-12%. For the rehabilitation material B, compared with the control group, the treatment groups with the amount of 0.2% and 0.4% also have significant effects, which are, however, not as much as the rehabilitation material A. The treatment groups have reduced WD content and CA content by 18% to 23% and 26% to 31%, respectively; in terms of RE content and OX content, there is no significant difference between the treatment groups and the blank control group; the treatment groups have increased RES values by 9% to 11%.

As can be seen from Table 5 and FIG. 2, after culture for 90 days, for the rehabilitation material A, compared with the blank control group, the treatment group with the amount of 0.4% has reduced WD content and CA content by 21.7% and 35.5%; in terms of the RE content and OX content, there is no significant difference between the treatment group and the blank control group; the treatment group has increased RES content by 10.6%. The treatment group with the amount of 0.2% has reduced WD content and CA content in soil by 16.2% and 25.9%, respectively; in terms of the RE content and OX content, there is no significant difference between the treatment group and the blank group; the treatment group has increased RES content by 8.2%. For the rehabilitation material B, compared with the blank control group, the treatment group with the amount of 0.4% has reduced WD content and CA content by 22.3% and 25.6%, respectively; in terms of the RE content and OX content, there is no significant difference between the treatment group and the blank control group; the treatment group has increased RES content by 6.3%. The treatment group with the amount of 0.2% has reduced WD content and CA content in soil by 23.3% and 24.9%, respectively; in terms of the RE content and OX content, there is no significant difference between the treatment group and the blank control group; the treatment group has increased RES value by 6.7%. It can be seen that rehabilitation material A has a longer-term effect than rehabilitation material B, and the amount of 0.4% has a better immobilization remediation effect than the amount of 0.2%.

As can be seen from the above embodiment, the rehabilitation material according to the present disclosure can reduce the bioavailability of heavy metal Cd in weakly alkaline soil and ensure a long-term effective immobilization effect on heavy metal Cd in soil. Moreover, it could balance the pH value of weakly alkaline soil, avoiding overly alkaline, having a significantly better effect than single alkali lignin and single iron mine tailing.

The foregoing descriptions are only preferred implementations of the present disclosure. It should be noted that for a person of ordinary skill in the art, several improvements and modifications may further be made without departing from the principle of the present disclosure. These improvements and modifications should also be deemed as falling within the protection scope of the present disclosure.

1. A rehabilitation material for reducing the bioavailability of Cd in soil, comprising an iron mine tailing and an alkali lignin;
wherein the iron mine tailing accounts for 80-90% of the sum of the masses of the iron mine tailing and the alkali lignin; and
the iron mine tailing is obtained by mixing an iron tailing, mica, and dolomite in a mass ratio of 1:1.5:2.5, and calcining the resulting mixture at 1100° C. for 1 hour.

2. The rehabilitation material as claimed in claim 1, wherein the alkali lignin comprises 42-46% by mass of C element, and the alkali lignin comprises 18-21% by mass of ash, wherein the ash comprises 27-33% by mass of Si, and 14-18% by mass of K.

3. The rehabilitation material as claimed in claim 1, wherein the alkali lignin has a weight-average molecular weight of 20,000-25,000, and a number-average molecular weight of 150-180.

4. The rehabilitation material as claimed in claim 1, wherein the iron tailing comprises 65-75% by mass of SiO₂; the mica comprises 7-11% by mass of K₂O; the dolomite comprises 27-32% by mass of CaO, and 15-25% by mass of MgO.

5. A method for immobilization remediation of weakly alkaline soil by using the rehabilitation material for reducing the bioavailability of Cd in soil as claimed in claim 1, wherein the weakly alkaline soil has a pH value of 7.1-7.5.

6. The method as claimed in claim 5, comprising
applying the rehabilitation material to a cultivation layer of the weakly alkaline soil; and
irrigating the cultivation layer, and balancing so that the rehabilitation material and the cultivation layer are mixed to be uniform.

7. The method as claimed in claim 6, wherein the cultivation layer is the surface layer of weakly alkaline soil within a depth of 0-20 cm.

8. The method as claimed in claim 6, wherein the rehabilitation material is applied in an amount of 0.35-0.45% of the dry weight of the cultivation layer.

9. The method as claimed in claim 8, wherein the rehabilitation material is applied in an amount of 0.4% of the dry weight of the cultivation layer.

10. The method as claimed in claim 6, wherein irrigating the cultivation layer is to keep the moisture content of the cultivation layer not less than 30% of the saturated moisture content of the cultivation layer, and the balancing is performed for 4-6 days.

11. The rehabilitation material as claimed in claim 2, wherein the alkali lignin has a weight-average molecular weight of 20,000-25,000, and a number-average molecular weight of 150-180.

12. The method as claimed in claim 5, wherein the alkali lignin comprises 42-46% by mass of C element, and the alkali lignin comprises 18-21% by mass of ash, wherein the ash comprises 27-33% by mass of Si, and 14-18% by mass of K.

13. The method as claimed in claim 5, wherein the alkali lignin has a weight-average molecular weight of 20,000-25,000, and a number-average molecular weight of 150-180.

14. The method as claimed in claim 5, wherein the iron tailing comprises 65-75% by mass of siO₂, the mica comprises 7-11% by mass of K₂O, the dolomite comprises 27-32% by mass of CaO, and 15-25% by mass of MgO.

15. The method as claimed in claim 7, wherein the rehabilitation material is applied in an amount of 0.35-0.45% of the dry weight of the cultivation layer.

16. The method as claimed in claim 7, wherein irrigating the cultivation layer is to keep the moisture content of the cultivation layer not less than 30% of the saturated moisture content of the cultivation layer, and the balancing is performed for 4-6 days.
